(19) United States
(12) Patent Application Publication
(10) Pub. No.: US 2016/0223702 A1
(43) Pub. Date: Aug. 4, 2016

(54) MULTI-COMPONENT INDUCTION LOGGING METHODS AND SYSTEMS HAVING A TREND-BASED DATA QUALITY INDICATOR

(71) Applicant: HALLIBURTON ENERGY SERVICES, INC., Houston, TX (US)

(72) Inventors: Junsheng Hou, Kingwood, TX (US); Luis E. San Martin, Houston, TX (US); Burkay Donderici, Houston, TX (US)

(73) Assignee: Halliburton Energy Services, Inc., Houston, TX (US)

(21) Appl. No.: 15/021,030

(22) PCT Filed: Oct. 7, 2013
(86) PCT No.: PCT/US13/63682

§ 371 Date: Mar. 10, 2016

(51) Int. Cl. G01V 3/28; G01V 3/38

(52) U.S. Cl. CPC G01V 3/28; G01V 3/38

(57) ABSTRACT

Various logging tools, systems, and methods are disclosed. An example method includes obtaining multi-component induction (MCI) measurements from a logging tool conveyed along a borehole through a formation. The method also includes comparing a plurality of the MCI measurements to determine one or more data quality indicators for the formation property based at least in part on a predetermined inequality pattern. The method also includes displaying the one or more data quality indicators.

### BACKGROUND

In the field of petroleum well drilling and logging, resistivity logging tools are frequently used to provide an indication of the electrical resistivity of rock formations surrounding an earth borehole. Such information regarding resistivity is useful in ascertaining the presence or absence of hydrocarbons. A typical resistivity logging tool includes a transmitter antenna and a pair of receiver antennas located at different distances from the transmitter antenna along the axis of the tool. The transmitter antenna is used to create electromagnetic fields in the surrounding formation. In turn, the electromagnetic fields in the formation induce an electrical voltage in each receiver antenna. Due to geometric spreading and absorption by the surrounding earth formation, the induced voltages in the two receiving antennas have different phases and amplitudes. Experiments have shown that the phase difference (Φ) and amplitude ratio (attenuation, A) of the induced voltages in the receiver antennas are indicative of the resistivity of the formation. The average depth of investigation (as defined by a radial distance from the tool axis) to which such a resistivity measurement pertains is a function of the frequency of the transmitter and the distance from the transmitter to the mid-point between the two receivers. Thus, one may achieve multiple radial depths of investigation of resistivity either by providing multiple transmitters at different distances from the receiver pair or by operating a single transmitter at multiple frequencies.

Many formations are electrically anisotropic, a property which is often attributable to extremely fine layering during the sedimentary build-up of the formation. Hence, in a formation coordinate system oriented such that the x-y plane is parallel to the formation layers and the z axis is perpendicular to the formation layers, resistivities Rₓ and R_{y} in directions x and y, respectively, are the same, but resistivity R_{z} in the z direction is different from Rₓ and R_{y}. Thus, the resistivity in a direction parallel to the plane of the formation (i.e., the x-y plane) is known as the horizontal resistivity, Rₕ, and the resistivity in the direction perpendicular to the plane of the formation (i.e., the z direction) is known as the vertical resistivity, Rᵥ.

Compared to the conventional induction measurement, multi-component induction (MCI) logging is a 9-component measurement, and its non-diagonal components (denoted as XY, XZ, YX, YZ, ZX, and ZY) are more strongly affected by the tool location variations in the hole (e.g., due to tool eccentricity and tool azimuth angle) compared to the ZZ component and diagonal components (XX and YY), leading to a relatively greater degree of sensitivity to undesirable borehole effects.

### BRIEF DESCRIPTION OF THE DRAWINGS

Accordingly, there are disclosed in the drawings and the following description multi-component induction (MCI) logging systems and methods with a trend-based data quality indicator to alert the user to regions having inconsistent and potentially unreliable measurements. In the drawings:

FIG. 1 shows an illustrative logging while drilling (LWD) environment with dipping formation beds;

FIG. 2 shows an illustrative wireline logging environment with dipping formation beds;

FIG. 3 shows an illustrative antenna configuration for an MCI logging tool;

FIG. 4 shows illustrative antenna sub-arrays for an MCI logging tool;

FIG. 5 shows a block diagram of an illustrative logging system;

FIG. 6 shows an illustrative visual representation of log data with a quality index.

FIG. 7 shows an illustrative method for determining data quality indicators for MCI measurements; and

FIG. 8 shows an illustrative flowchart for iterative MCI logging using data quality indicators.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Disclosed herein are multi-component induction (MCI) logging systems and methods with one or more data quality indicators. The data quality indicators are qualitative and/or quantitative measures of MCI measurement consistency for different runs of an MCI logging tool in a borehole, for different frequencies of the MCI logging tool, and/or for different sub-arrays of the MCI logging tool. The data quality indicators may correspond to raw measurement data, to processed measurement data, and/or to inversion results such as a formation dip value, a horizontal resistivity value (Rₕ), and a vertical resistivity value (Rᵥ). The data used to determine the data quality indicators may correspond to data collected after calibration and/or temperature correction. Such data quality indicators may be computed, stored, and displayed to an operator. Further, customer reports generated for MCI logging results may include such data quality indicators. Additionally or alternatively, such data quality indicators may be used in an iterative logging process, where logging runs are repeated with updated workflow parameters until resulting data quality indicators satisfy a cost function.

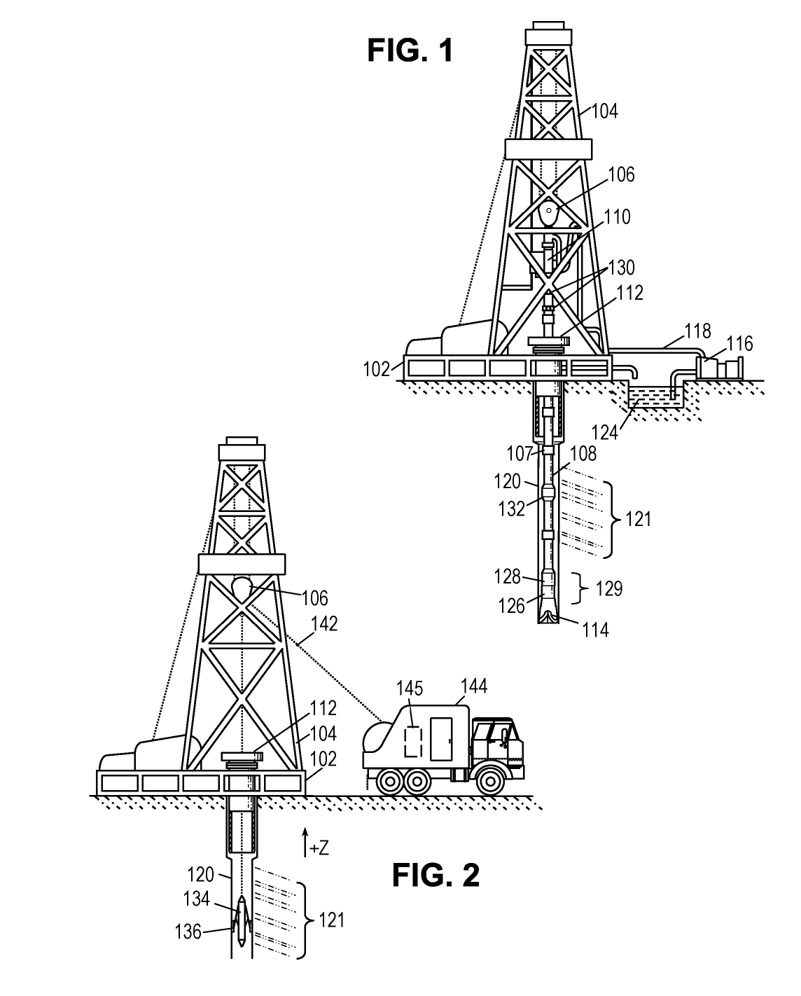

FIG. 1 shows a suitable context for describing the operation of the disclosed systems and methods. In the illustrated logging while drilling (LWD) environment, a drilling platform 102 is equipped with a derrick 104 that supports a hoist 106 for raising and lowering a drill string 108. The hoist 106 suspends a top drive 110 that rotates the drill string 108 as it is lowered through the well head 112. The drill string 108 can be extended by temporarily anchoring the drill string 108 at the well head 112 and using the hoist 106 to position and attach new drill pipe sections with threaded connectors 107.

Connected to the lower end of the drill string 108 is a drill bit 114. As bit 114 rotates, it creates a borehole 120 that passes through various formations 121. A pump 116 circulates drilling fluid through a supply pipe 118 to top drive 110, through the interior of drill string 108, through orifices in drill bit 114, back to the surface via the annulus around drill string 108, and into a retention pit 124. The drilling fluid transports cuttings from the borehole 120 into the pit 124 and aids in maintaining the integrity of the borehole 120.

Drilling fluid, often referred to in the industry as “mud”, is often categorized as either water-based or oil-based, depending on the solvent. Oil-based muds are generally preferred for drilling through shale formations, as water-based muds have been known to damage such formations.

An MCI logging tool 126 is integrated into a bottom-hole assembly 129 near the bit 114. The MCI logging tool 126 may take the form of a drill collar, i.e., a thick-walled tubular that provides weight and rigidity to aid the drilling process. As the bit extends the borehole 120 through the formations, the bottomhole assembly 129 collects multi-component induction measurements (using tool 126) as well as measurements of the tool orientation and position, borehole size, drilling fluid resistivity, and various other drilling conditions.

The orientation measurements collected by bottomhole assembly 129 may be obtained using an orientation indicator, which may include magnetometers, inclinometers, and/or accelerometers, though other sensor types such as gyroscopes may be used. Preferably, the orientation indicator includes a 3-axis fluxgate magnetometer and a 3-axis accelerometer. The combination of those two sensor systems enables the measurement of the rotational (“toolface”) angle, borehole inclination angle (“slope”), and compass direction (“azimuth”). In some embodiments, the toolface and borehole inclination angles are calculated from the accelerometer sensor output. The magnetometer sensor outputs are used to calculate the borehole azimuth. With the toolface, the borehole inclination, and the borehole azimuth information, multi-component induction logging tools disclosed herein can be used to steer the bit to the desirable bed. Formation dip and strike values can also between determined and used to steer the bit.

In wells employing acoustic telemetry for LWD, downhole sensors (including MCI logging tool 126) are coupled to a telemetry module 128 having an acoustic telemetry transmitter that transmits telemetry signals in the form of acoustic vibrations in the tubing wall of drill string 108. An acoustic telemetry receiver array 130 may be coupled to tubing below the top drive 110 to receive transmitted telemetry signals. One or more repeater modules 132 may be optionally provided along the drill string to receive and retransmit the telemetry signals. Of course other telemetry techniques can be employed including mud pulse telemetry, electromagnetic telemetry, and wired drill pipe telemetry. Many telemetry techniques also offer the ability to transfer commands from the surface to the bottomhole assembly 129, thereby enabling adjustment of the configuration and operating parameters of MCI logging tool 126. In some embodiments, the telemetry module 128 also or alternatively stores measurements for later retrieval when the bottomhole assembly 129 returns to the surface.

At various times during the drilling process, the drill string 108 is removed from the borehole 120 as shown in FIG. 2. Once the drill string has been removed, logging operations can be conducted using a wireline logging tool 134, i.e., a sensing instrument sonde suspended by a cable 142 having conductors for transporting power to the tool 134 and communications from the tool 134 to the surface. An MCI logging portion of the wireline logging tool 134 may have centralizing arms 136 that center the tool 134 within the borehole 120 as the tool 134 is pulled uphole. A logging facility 144 collects measurements from the wireline logging tool 134, and includes computing facilities 145 for processing and storing the measurements gathered by the wireline logging tool 134.

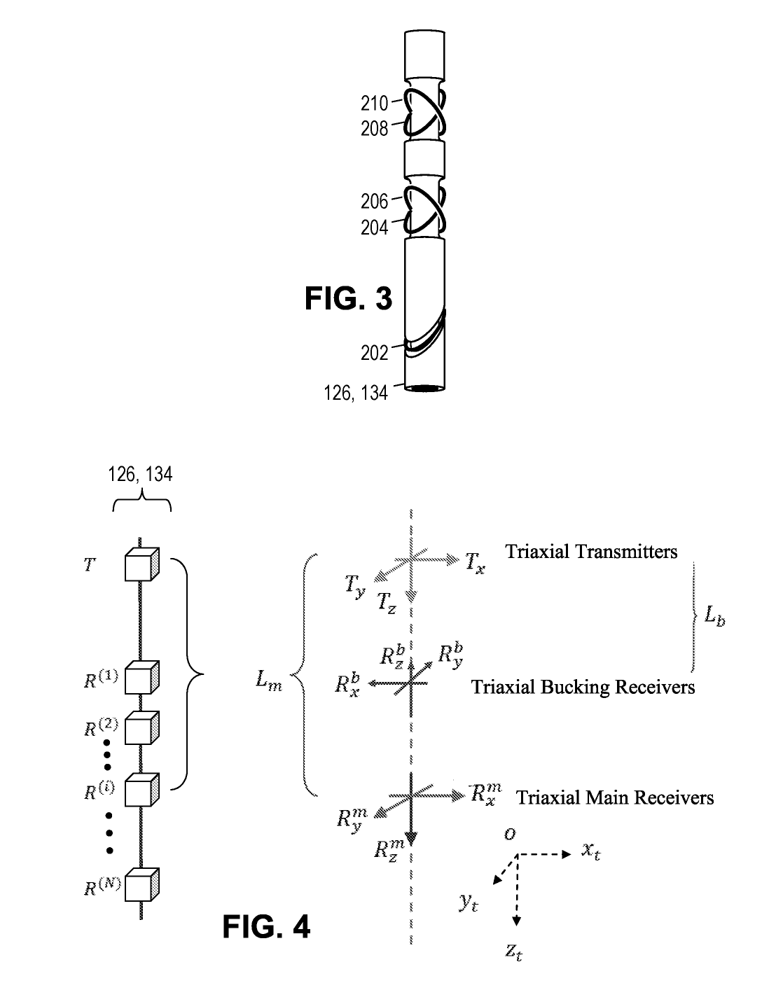

FIG. 3 shows an illustrative antenna configuration for MCI logging tool 126 or 134. As shown, MCI logging tool 126 or 134 has a tilted transmit antenna 202 and two pairs of tilted receive antennas 204, 206 and 208, 210, thereby providing four transmit-receive antenna pairings. As the MCI logging tool 126 or 134 moves along a borehole, it acquires attenuation and phase measurements of each receive antenna's response to transmit antenna 202. In certain alternative embodiments, the MCI logging tool 126 or 134 measures in-phase and quadrature-phase components of the receive signals rather than measuring amplitude and phase. In either case, these measurements are collected and stored as a function of the MCI logging tool's position and orientation in the borehole.

The illustrated MCI logging tool 126 or 134 of FIG. 3 has receive antennas 204 and 208 oriented parallel to the transmit antenna 202, and receive antennas 206 and 210 oriented perpendicular to the transmit antenna 202. In the illustrated example, each of the antennas share a common rotational orientation, with antennas 202, 204, 208 being tilted at −45° and antennas 206, 210 being tilted at +45° relative to the longitudinal tool axis. In a LWD embodiment (MCI logging tool 126), each of the coil antennas is mounted in a recess and protected by a non-conductive filler material and/or a shield having non-conducting apertures, and tool body is primarily composed of steel. In a wireline embodiment (MCI logging tool 136), the coil antennas may be mounted inside or outside a mandrel made of fiberglass or other materials. For both LWD and wireline embodiments, the relative MCI logging tool dimensions and antenna spacings are subject to variation depending on the desired tool properties. As an example, the distance between the receive coil pairs may be on the order of 0.25 m, while the spacing of the transmit coil to the midpoint between the receiver pairs may vary from about 0.4 m to over 10 m.

FIG. 4 shows illustrative antenna sub-arrays for MCI logging tool 126 or 134. In FIG. 4, each antenna sub-array includes transmitter triad Tₓ, T_{y}, T_{z}, which represent magnetic dipole antennas oriented parallel to the tool's x, y, and z axes respectively (denoted as xₜ, yₜ, zₜ). Each sub-array also includes a main receiver triad, Rₓ^{m}, R_{y}^{m}, R_{z}^{m}, and a bucking receiver triad Rₓ^{b}, R_{y}^{b}, R_{z}^{b}, all of which represent magnetic dipole antennas oriented parallel to the tool's x, y, and z axes respectively. For a given sub-array, the main receiver triad is spaced at a distance Lₘ from the transmitter triad, and the bucking receiver triad is spaced at a distance L_{b} from the transmitter triad. Thus, the MCI logging 126 or 134 is represented in FIG. 4 as N tri-axial sub-arrays (i.e., TR⁽¹⁾, TR⁽²⁾, . . . , and TR^{(N)}), where each tri-axial sub-array includes a transmitter triad (Tₓ, T_{y}, and T_{z}), a main receiver triad (Rₓ^{m}, R_{y}^{m}, and R_{z}^{m}), and a bucking receiver triad (Rₓ^{b}, R_{y}^{b}, and R_{z}^{b}). In accordance with at least some embodiments, each antenna sub-array measures a nine-coupling voltage measurement at every log depth in the tool/measurement coordinate system (xₜ, yₜ, zₜ).

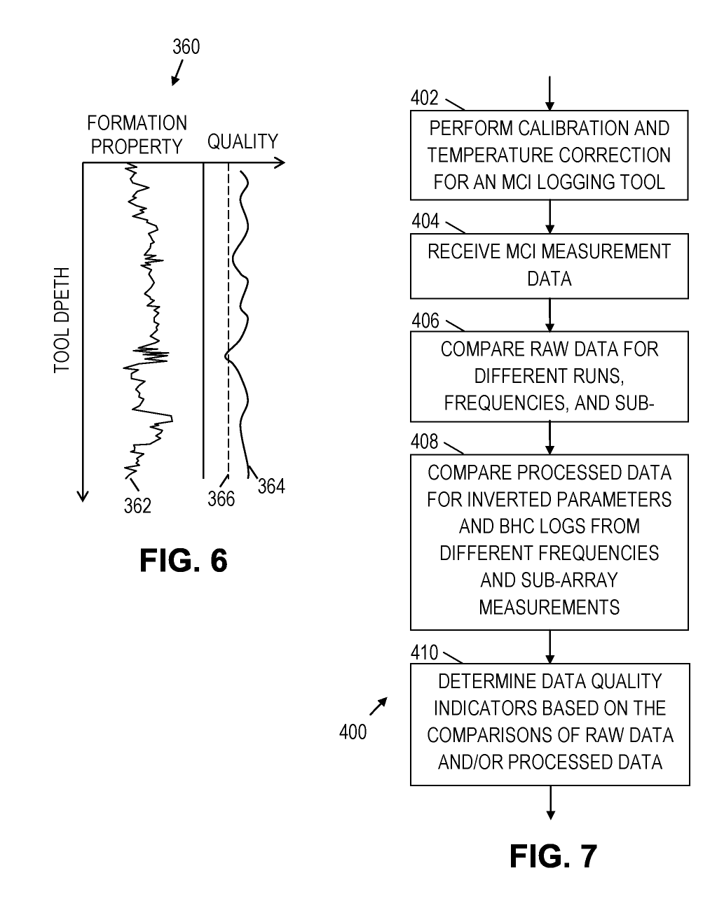

The voltages measured on receivers of a sub-array can be converted into apparent conductivities. In at least some embodiments, the apparent conductivities are symbolically expressed in equation 1 as a 3×3 tensor or matrix for a multi-array tri-axial tool operated at multiple frequencies:

$${{σ}_{a}^{( i , j )}}^{\overline{\_}} = ( \begin{matrix}{σ}_{xx}^{( i , j )} & {σ}_{xy}^{( i , j )} & {σ}_{xz}^{( i , j )} \\ {σ}_{yx}^{( i , j )} & {σ}_{yy}^{( i , j )} & {σ}_{yz}^{( i , j )} \\ {σ}_{zx}^{( i , j )} & {σ}_{zy}^{( i , j )} & {σ}_{zz}^{( i , j )}\end{matrix} ) = {( {σ}_{IJ}^{( i , j )} )}_{( 3 \times 3 )} , \qquad ( 1 )$$

where i=1, 2, . . . , N , j=1, 2, . . . , M , N is the total number of the tri-axial sub-arrays, and M is the total number of the operated frequencies. In equation 1, σ̅ₐ̅^̅{̅(̅i̅,̅ j̅)̅}̅ is referred to as the MCI apparent conductivity tensor (R-signal or X-signal) in the tool coordinate system, σ_{IJ}^{(i, j)} are the measured-conductivity couplings of σ̅ₐ̅^̅{̅(̅i̅,̅ j̅)̅}̅, where I indicates the transmitter direction, and J indicates the receiver direction. For example, when I and J=x, σ_{IJ}^{(i, j)} is σₓₓ^{(i, j)}, when I and J=y, σ_{IJ}^{(i, j)} is σ_{yy}^{(i, j)}, and when I and J=z, σ_{IJ}^{(i, j)} is σ_{zz}^{(i, j)}, which are the traditional multi-array induction measurements. Including both R-signal and X-signal data yields 2*9*M*N measurements for every log point. As disclosed in greater detail for FIG. 6, a data quality indicator may be determined at least in part by comparing different conductivity measurements.

In at least some embodiments, resistivity information (e.g., Rᵥ, and Rₕ), formation dip information, distance information, and/or other information are plotted or mapped by visualization software (e.g., the visualization control module 320) that receives measurements from MCI logging tool 126 or 134. Without limitation, the parameters that are displayed or represented by visualization software may include physical parameters such as tool orientation, formation resistivity values, Rᵥ, Rₕ, formation dip, relative dip angles, strike angles, relative azimuth angles, bed dips, bed azimuths, drill path, distance to bed boundaries, water saturation, and formation porosity. In addition, trust values such as uncertainty estimates, inversion type information, and/or comparison information may be displayed or represented by visualization software. In addition, data quality indicators related to physical parameters may be displayed or represented.

By displaying or representing physical values, trust values, and/or data quality indicators, visualization software enables an operator to prepare a report. Alternatively, a report on measured physical parameters with data quality indicators may be generated automatically using software without input (or with limited input) from an operator. Further, an operator may select logging workflow adjustments for MCI logging tool 126 or 134 using visualized physical parameters and data quality indicators. In at least some embodiments, the logging process and workflow adjustments continue until the data quality indicators are greater than a threshold level and/or satisfy a cost function associated with the logging process.

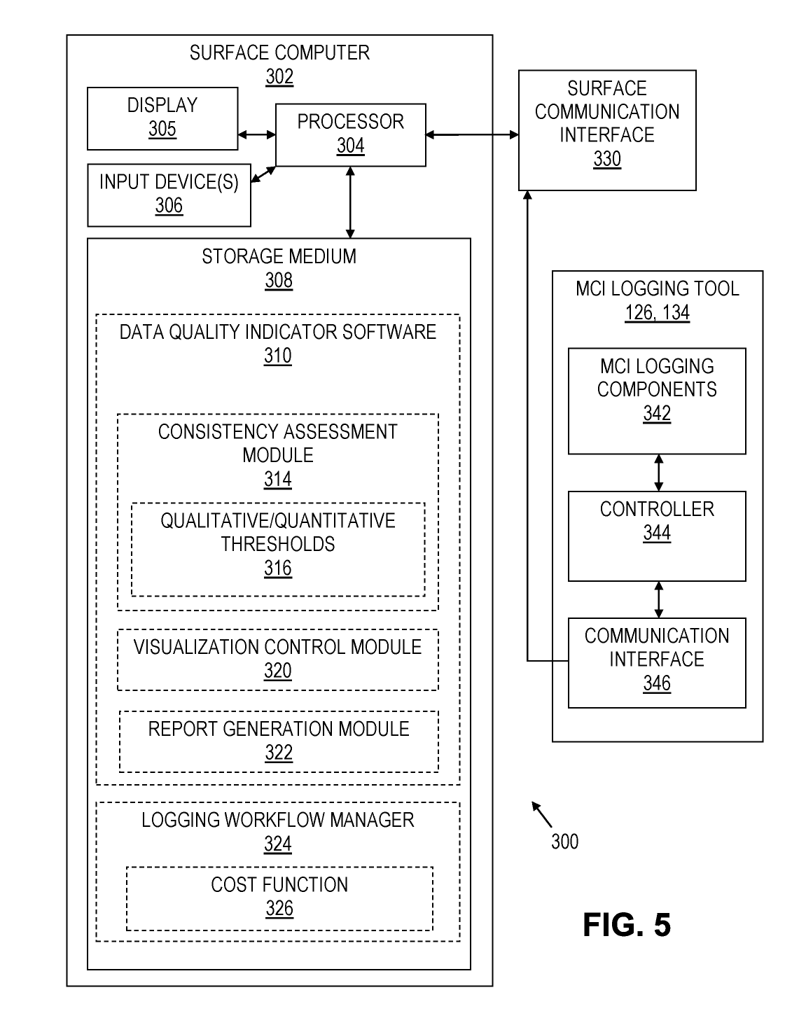

FIG. 5 shows a block diagram of an illustrative logging system 300. The logging system 100 includes an MCI logging tool 126 or 134 with MCI logging components 342 to collect MCI measurements. For example, the MCI logging components 342 may correspond to the antenna configuration of FIG. 3 and/or the antenna sub-arrays described in FIG. 4. The MCI logging tool 126 or 134 also includes a controller 344 to direct various operations of the MCI logging tool 126 or 134. The operations include setting or adjusting parameters for collecting raw data, processing the raw data, storing the raw and/or processed data, and transmitting the raw and/or processed data to the surface. A communication interface 346 of the MCI logging tool 126 or 134 enables MCI measurement data to be transferred to a surface communication interface 330. The surface communication interface 330 provides the MCI measurement data to a surface computer 302 using known communication techniques (e.g., mud pulse, electromagnetic signaling, or a wired pipe arrangement). It should be understood that the MCI measurement data provided to the surface computer 302 from the MCI logging tool 126 or 134 may include raw measurement data, processed measurement data, inverted measurement data, visualization parameters, and/or data quality indicators.

As shown in FIG. 5, the surface computer 302 includes at least one processor 304 coupled to a display 305, input device(s) 306, and a storage medium 308. The display 305 and input device(s) 306 function as a user interface that enables an operator (i.e., a drilling operator and/or logging operator) to view information, to input steering commands, to input logging workflow commands or values, and/or to interact with other software executed by processor 304.

In at least some embodiments, the storage medium 308 stores data quality indicator software 310 with a consistency assessment module 314, a visualization control module 320, and a report generation module 322. The storage medium 308 also includes a logging workflow manager 324. Accordingly, in at least some embodiments, the input device(s) 306 (e.g., a touch screen, mouse, and/or keyboard) enables an operator to interact with the data quality indicator software 310. Further, the input device(s) 306 may enable an operator to interact with a steering interface that assists the operator with steering decisions using visual representations of a formation. It should be understood that the operations of the data quality indicator software 310 apply to wireline logging systems as well as LWD systems.

In at least some embodiments, consistency assessment module 314 of the data quality indicator software 310 determines whether multi-run measurements collected by MCI logging tool 126 or 134 are stable or repeatable. Further, the consistency assessment module 314 determines whether single-run measurements collected by MCI logging tool 126 or 134 are consistent. To determine data quality indicators, the variation in single-run and/or multi-run measurements are compared. For example, a predetermined inequality pattern may be used to assess the quality of single-run measurements. Further, the degree of variation in single-run may be used to assess the quality single-run measurements. If available, the degree of variation in multi-run measurements may be used to assess the quality of multi-run measurements. In different embodiments, data quality indicators may be provided for raw measurement data, for processed measurement data, and/or for inversion results (e.g., a formation dip value, Rₕ, and Rᵥ). Some example comparisons and data quality indicators are provided below.

In at least some embodiments, calibrations and/or temperature corrections may be applied to the MCI logging tool 126 or 134 to improve measurement quality. However, some data quality issues (e.g., due to loose parts) cannot be overcome by calibration and temperature correction, but the degree of difference can still be tracked and corresponding data quality indicators may be generated.

Returning to the multi-array MCI tool notation of FIG. 4, the consistency assessment module 314 may perform various types of conductivity measurement analysis. Numerical simulations indicate analysis of combined MCI responses is appropriate. The basis for the combined response analysis is that even though all MCI responses are affected by tool position in a borehole (especially cross components σ_{IJ}^{(i, j)}), where I≠J), the effects of the tool position on some combined MCI responses may be reduced in the strike coordinate system. Accordingly, combined MCI responses may replace the raw data for the comparisons of different run measurements performed by the consistency assessment module 314.

Further, numerical simulations indicate that for a given sub-array, MCI responses usually satisfy inequality equations for different frequencies (f₍ⱼ₎, j=1, 2, . . . , M):

σ_{IJ}^{(i, j+1)}≦σ_{IJ}^{(i, j)}≦σ_{IJ}^{(i, j-1)} or σ_{IJ}^{(i, j+1)}≧σ_{IJ}^{(i, j)}≧σ_{IJ}^{(i, j-1)}, (2)

where in a homogeneous full space or a thick-bed formation with or without a hole, the frequency values satisfy f₍ⱼ₊₁₎>f₍ⱼ₎>f₍ⱼ₋₁₎. Thus, the consistency assessment module 314 may determine whether MCI responses satisfy these inequality equations for different frequencies.

Further, numerical simulations indicate that for given frequencies (f₍ⱼ₎), the MCI responses usually satisfy inequality equations for different sub-arrays (i=1, 2, . . . , N):

σ_{IJ}^{(i+1, j)}≦σ_{IJ}^{(i, j)}≦σ_{IJ}^{(i-1, j)} or σ_{IJ}^{(i+1, j)}≧σ_{IJ}^{(i, j)}≧σ_{IJ}^{(i-1, j)}, (3)

where in a full space or a thick-bed formation with or without a hole, the sub-array spacing values satisfy L₍ᵢ₋₁₎>L₍ᵢ₎>L₍ᵢ₊₁₎. Thus, the consistency assessment module 314 may determine whether MCI responses satisfy these inequality equations for different sub-arrays.

Accordingly, in at least some embodiments, the consistency assessment module 314 may utilize combined MCI responses, inequality equations for different frequencies, and/or inequality equations for different sub-arrays to determine data quality indicators. Further, the ratios for different frequencies and sub-arrays may be computed from inverted formation parameters and compared with predetermined thresholds.

Without limitation, a data quality indicator determined by the data quality indicator software 310 may be a binary value, where one state is “good quality” and other state is “bad quality”. Alternatively, a data quality indicator may have three or more levels. For example, a data quality indicator may be an integer with a value of 1 to 5, where 1 is “bad quality”, 2 is “fair quality”, 3 is “acceptable quality”, 4 is “good quality”, and 5 is “excellent quality”. Additional levels or fractional numbers may also be used as a data quality indicator value.

In at least some embodiments, the value of a data quality indicator may be lowest (e.g., 1 on a scale of 1 to 5) if an inequality pattern (equations 2 or 3) for MCI responses is not met. Further, the value of a data quality indicator may differ depending on measurement deviations. For example, if the inequality pattern is met, the following data quality indicator values may be selected: a 1 may be selected if the deviation is larger than 50%; a 2 may be selected if the deviation is between 20% and 50%, a 3 may be selected if the deviation is between 10% and 20%, a 4 may be selected if the deviation is between 5% and 10%, and a 5 may be selected if the deviation is smaller than 5%.

If available, multi-run data is analyzed to determine repeatability of MCI measurements. Additionally or alternatively, raw data is analyzed to determine logging environment issues and/or potential tool issues. Additionally or alternatively, processed data is analyzed to determine potential issues with processing as well as logging environment issues. In at least some embodiments, the decision regarding which data to analyze may depend on customer input regarding which frequency or frequencies to use. If a multi-frequency result is going to be delivered to the customer, then quality of the multi-frequency results can be analyzed to determine data quality indicators relevant to a customer request. Thus, determined data quality indicators may be relevant to a frequency or frequencies of interest to a customer, and/or to physical parameters of interest.

Returning to FIG. 5, the data quality indicator software 310 also comprises visualization control module 320, which may display MCI measurement results or related data. For example, the visualization control module 320 may cause resistivity information (Rᵥ and Rₕ), formation dip, strike angle, distance information, or other information to be plotted and displayed to an operator. Without limitation, the parameters that are displayed or represented by visualization control module 320 may include physical parameters such as tool orientation, formation resistivity values, vertical resistivity, horizontal resistivity, relative dip angles, relative azimuth angles, bed dips, bed azimuths, drill path, distance to bed boundaries, water saturation, and formation porosity. In addition, trust values such as uncertainty estimates, inversion type information, and/or comparison information may be displayed or represented by visualization control module 320. In addition, data quality indicators related to physical parameters may be displayed or represented by visualization control module 320. As an example, data quality values related to data quality ranges or indices may be used as data quality indicators.

The data quality indicator software 310 also comprises report generation module 322 to generate a MCI logging report with data quality indicators. In at least some embodiments, the report generated by report generation module 322 includes physical parameters values, trust values, and/or data quality indicators. The information in the report may be generated based on operator input, report generation rules, or both. As an example, an operator may view information presented by the visualization control module 320, and may generate or update a report accordingly. Alternatively, report generation module 322 may generate a report without operator input or with limited operator input (e.g., an operator may edit a report that has already been generated). In some embodiments, a report is not generated until data quality criteria of MCI logging operations are met (as indicated by the data quality indicators).

As shown in FIG. 5, the storage medium 308 of surface computer 302 also includes a logging workflow manager 324 that enables logging control parameters, processing control parameters, inversion control parameters, visualization parameters, report generation, and/or data quality analysis to be adjusted for different logging runs. The adjustments made by the logging workflow manager 330 may be directed using operator input and/or established rules. Without limitation, the logging workflow manager 330 may enable adjustments to: the visualization of measurement data; filter types or filter coefficients; signal selection or signal weights; frequencies used; processing parameters; and/or other logging parameters (e.g., logging speed and power levels) based on automation rules. In at least some embodiments, the logging workflow manager 324 employs a cost function 326 to determine whether to perform additional measurement runs, where the cost function 326 relies on data quality indicators determined by the data quality indicator software 310. Accordingly, logging workflow adjustments and additional runs by MCI logging tool 126 or 134 may continue until the cost function 332 is satisfied (e.g., if the data quality is above a threshold range, if the data quality is not improving, if the data quality has improved by more than a threshold percent compared to an initial quality threshold, and/or if the data quality has not improved by more than a threshold percent compared to an initial quality threshold), or until an operator selects to end logging operations. Further, the logging workflow manager 330 may provide a user interface that enables an operator to make adjustments to the automation rules, to the logging workflow of different runs and/or to the cost function 332.

Although the data quality indicator software 310 and logging workflow manager 330 are described as software or modules stored by storage medium 308 and executed by processor 304, it should be understood that at least some features of the data quality indicator software 310 and logging workflow manager 330 may be stored and executed by MCI logging tool 126 or 134.

FIG. 6 shows an illustrative visual representation 360 of log data with a quality index. The visual representation 360 may be displayed, for example, on a computer monitor or in a report generated based on the MCI measurements described herein. As shown, the visual representation 360 charts a formation property log 362 as a function of depth. The formation property log 362 may correspond to raw data (e.g., conductivity measurements), processed data (e.g., combined MCI measurements), or inversion data (e.g., Rᵥ, Rₕ, formation dip, formation strike) as described herein. The visual representation 360 also charts a quality log 364 as a function of depth. Thus, the example quality log 364 charts how data quality of the formation property log 362 varies as function of depth. The quality log 362 is determined, for example, by combining a plurality of data quality indicators for different depths. In at least some embodiments, a threshold indicator 366 is also displayed to indicate tool depths at which the quality of the formation property log 362 drops below a threshold level. Additional thresholds may be displayed to categorize data quality into finer groupings.

The visual representation 360 of FIG. 6 is an example of displaying data quality indicators using position of a continuous line (the quality log 364 indicates higher data quality towards the right). In different embodiments, data quality indicators can be represented in other ways. For example, data quality indicators can be represented using a plurality of separate lines or symbols, where the position of the lines or symbols indicates quality. Further, data quality indicators can be represented as numerical values in a scale (e.g., 1 to 5, where 1 is lowest quality and 5 is highest quality), or as colors (e.g., red to green, where red in lowest quality and green is highest quality). In summary, the format of visual representation 360 is one of many possible ways to display measurement results and corresponding data quality indicators. Such data quality indicators may be included in a log report for review by an operator or customer. Additionally or alternatively, such data quality indicators may be utilized by an operator or automation rules to update logging control parameters.

FIG. 7 shows a method 400 for determining data quality indicators for MCI measurements. The method 400 may be performed by surface computer 302 and/or MCI logging tool 126 or 134. As shown, the method 400 includes performing calibration and temperature correction for MCI logging tool 126 or 134 (block 402). At block 404, MCI measurement data is received. The received MCI measurement data may correspond to MCI measurements associated with multiple runs, multiple frequencies, and/or multiple sub-arrays. At block 406, raw data for different runs, for different frequencies, and/or for different sub-arrays are compared. For example, the comparison may determine whether measurements follow a predetermined inequality pattern (e.g., equations 2 or 3), the degree of difference between single-run measurements at different frequencies, the degree of different between single-run measurements for different sub-arrays, and/or the degree of difference between multi-run measurements. At block 408, processed data for inverted parameters (e.g., formation dip, Rᵥ, and Rₕ) and borehole compensated (BHC) logs for different frequencies and/or for different sub-arrays are compared to determine the degree of different between processed results. At block 410, data quality indicators for the MCI measurements are determined based on the comparisons of raw data and/or processed data as described herein.

In at least some embodiments, the method 400 may include various other steps. More specifically, step 406 and/or step 408 may include calculating the relative difference or standard deviation of measurements from different runs. Further, a determination regarding whether measurement distribution is within a threshold may be used to determine a data quality indicator. For cross components of multi-run measurements, the strike angle may be computed using MCI responses. Once the strike is known, MCI responses may be rotated to a zero-degree strike angle to obtain MCI data in the strike system. Further, combined MCI responses for different runs may be computed. Subsequently, the combined MCI responses are compared and the relative differences and standard deviations are determined. In at least some embodiments, a difference or deviation of up to 5% is acceptable.

As an example, the main-run measurements for different frequencies (e.g., 12, 36, 60, and 84 kHz for Xaminer™ MCI tool) and different sub-arrays may be compared. From the comparison of available multi-run measurements, a determination is made regarding whether there is a threshold agreement between all nine components (this shows the measurements are sufficiently precise). In order to reduce the effects of the so-called bias or systematic error and tool positions, other data comparisons are conducted (e.g., comparing combined signals, comparing measurements for different frequencies, and/or comparing measurements for different sub-arrays) to determine if data quality criteria are met and/or to determine data quality indicators as described herein. For example, if inequalities (e.g., σ_{IJ}^{(i+1, j)}≦σ_{IJ}^{(i, j)}≦σ_{IJ}^{(i-1, j)} or σ_{IJ}^{(i+1, j)}≧σ_{IJ}^{(i, j)}≧σ_{IJ}^{(i-1, j)}) are observed for different frequencies at a given run and sub-array, or for different sub-arrays of a given run and frequency, then at least some data quality criteria are considered to be met and the data quality indicators will so indicate.

In at least some embodiments, block 408 includes processing MCI data (e.g., radially one-dimensional (R1D) inversion and BHC) to obtain inverted parameters such as formation dip, Rₕ and Rᵥ. Further, the processed MCI data may be compared (e.g., comparing measurements for different frequencies and/or different sub-arrays) to determine relative differences and deviations for multiple measurements.

In at least some embodiments, step 408 includes computing the relative error or standard deviation (e.g., to quantitatively measure the consistency of inversion results) for different frequency measurements and/or different sub-array measurements. More specifically, the data quality of the raw measurements may be computed as:

$${e}_{r}^{( j )} = \vert \frac{{x}_{j} - \overline{x}}{\overline{x}} \vert , j = 1 , 2 , … , M , \qquad ( 4 )$$

where xⱼ represents the inverted parameter (e.g., xⱼ may be formation dip, Rₕ, Rᵥ, the log transformation of Rₕ(xⱼ=log(Rₕ)), or the log transformation of Rᵥ(xⱼ=log(Rᵥ)) of the MCI measurement at the j-th frequency for the i-th sub-array). The value xⱼ−x̅ is sometimes called the mean error or difference of xⱼ. In equation 4, eᵣ^{(j)} is the relative difference between xⱼ and x̅ and is sometimes expressed as a percentage (i.e., relative difference percentage=eᵣ^{(j)}×100). Further, x̅ may be the arithmetic or weighted mean of the multi-frequency inverted results (x₁, x₂, . . . , x_{M}) expressed as,

$$\overline{x} = \frac{1}{M} {\sum }_{j = 1}^{M} {x}_{j} , or \overline{x} = {\sum }_{j = 1}^{M} {w}_{j} {x}_{j} , \qquad ( 5 )$$

where

$${\sum }_{j = 1}^{M} {w}_{j} = 1 ,$$

0≦wⱼ≦1 and the standard deviation (variance) or weighted deviation is expressed as,

$$v = \frac{1}{M - 1} {\sum }_{j = 1}^{M} {( {x}_{j} - \overline{x} )}^{2} , S = \sqrt{v} , or \\ S = \sqrt{{\sum }_{j = 1}^{M} {w}_{j} \cdot {( {x}_{j} - \overline{x} )}^{2}} . \qquad ( 6 a )$$

Alternatively, the ratio of the standard deviation to the mean may be computed as,

$${S}^{′} = \frac{S}{\overline{x}} , \qquad ( 6 b )$$

where the ratio S′ is the coefficient of variation for a measurement, and is independent of measurement units.

In at least some embodiments, equation 4 may be used to evaluate the data differences for frequency inversions, and equations 6a and 6b are used to evaluate the data differences for multi-frequency inversion results. The relative difference or deviation describes the spread or dispersion of different frequency inversion results about the mean. For example, a small standard deviation indicates that all inverted results are clustered tightly around a mean value. Conversely, a large standard deviation indicates that the inverted values are scattered widely about the mean. In practice, differences are observed due to the measured errors and limitations of the processing methods. Thus, similar inverted results for different sub-arrays and frequencies indicate indirectly a higher data quality.

In at least some embodiments, step 410 may include determining data quality indicators in a variety of ways. For example, inequality patterns (e.g., equations 2 or 3) and measurement deviations may be used as previously discussed. In addition, values of eᵣ^{(j)} and S may be used, where smaller values of eᵣ^{(j)} and S indicate better data quality and can be used to select a data quality indicator accordingly. Further, data error for one or more components of different sub-arrays and frequencies may be compared with the values of eᵣ^{(j)} and S computed from the comparison of inversion parameters to determine a data quality indicator.

In at least some embodiments, the method 400 combines raw data comparisons and MCI data processing for the evaluation of measured data quality. Even if the multiple run measurements are not available, method 400 is able to determine a reasonable data quality indicator. In such case, the amount of logging time in the field may be reduced. In at least some embodiments, method 400 determines data quality indicators throughout the process of data acquisition, processing, and interpretation.

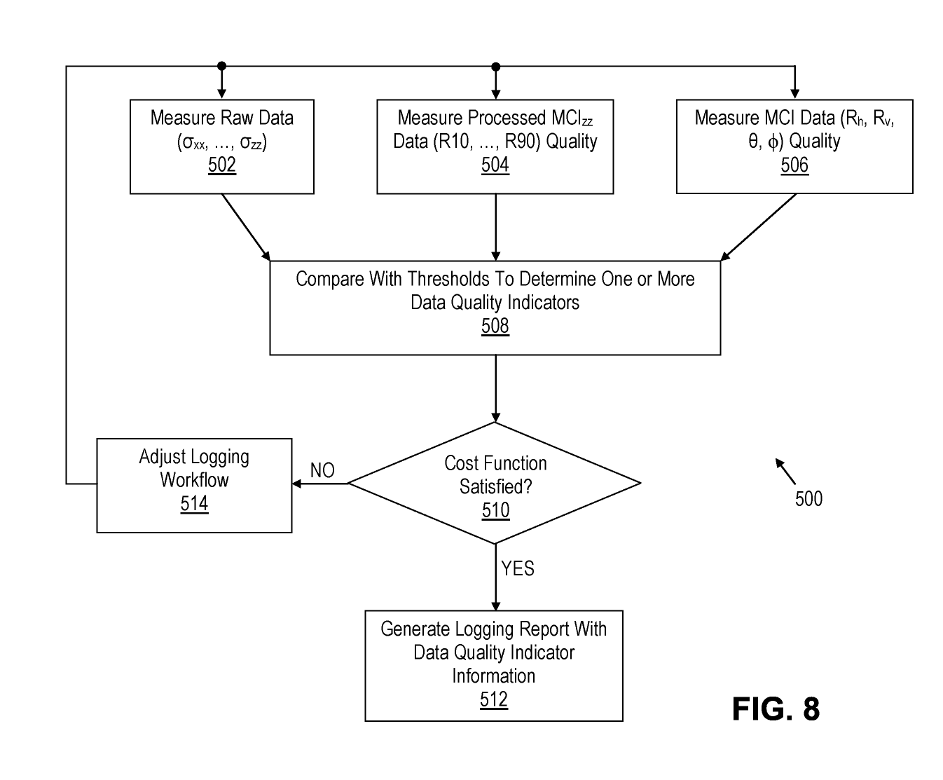

FIG. 8 shows an illustrative flowchart 500 for iterative MCI logging using data quality indicators. The method 500 may be performed by surface computer 302 and/or MCI logging tool 126 or 134. As shown, the method 500 includes measuring raw data (σₓₓ, . . . , σ_{zz}) at block 502, measuring processed MCI_{zz} data (R10, . . . , R90) quality at block 504, and measuring MCI data (e.g., Rₕ, Rᵥ, dip, strike) at block 506. At block 508, the data measured at blocks 502, 504, and 506 are compared with thresholds to determine one or more data quality indicators. For example, the thresholds may correspond to an inequality pattern (equations 2 or 3) or measurement deviation thresholds as described herein. It should be noted that not all of the data from blocks 502, 504, and 506 need be utilized at block 508 (data from one of blocks 502, 504, 506 is sufficient). However, utilization of more data at block 508 can provide information for a wider range of stability and consistency issues. If a cost function is satisfied (determination block 510), a logging report is generated with data quality indicator information (block 512). If the cost function is not satisfied (determination block 512), a logging workflow is adjusted (block 514), and the method 500 returns to blocks 502, 504, and 506, and the steps of method 500 are repeated until the cost function is satisfied (determination block 510), or until an operator selects to end logging operations. In at least some embodiments, raw data, processor data, or inversion parameters can be displayed for analysis or reporting along with data quality indicators even if the cost function is not satisfied. In other words, step 512 may be performed after step 508 without regard to decision block 510.

The method 500 illustrates that data quality indicators can be used in a feedback loop, where logging results are improved by adjusting workflow parameters such as visualization parameters, processing parameters, or other controllable parameters. In at least some embodiments, updating visualization parameters involves marking or removing data with low quality from logs. Such marking can be performed by placing arrows or text in low quality zones, or placing a curve that indicates the quality of the logs. It is also possible to adjust filters that are used in reduction of noise or horn effects. For example, filter cut-offs can be moved and the bands can be made wider or narrower depending on the requirements. Further, if too much horn effect or noise is found in the curves, filters can be adjusted to allow less of the signal out. Further, if a signal is very high in quality, filters can be adjusted to allow for more of the signal out. Filters can also be designed based on the quality parameters obtained for optimization. It is also possible to adjust the signal selection that is used in various stages of processing. For example, spacing that will be used in RID processing can be changed based on data quality indicators. In addition, the frequency that will be delivered can be chosen based on data quality indicators. In at least some embodiments, less weight can be given to signals with less quality, and vice-versa. It is also possible to switch an MCI logging tool to a different set of frequencies. As an example, if high frequencies are found to be more accurate, a frequency set centered around a high frequency can be used. It is also possible to adjust the listening time for each frequency based on data quality indicators. Finally, a fluid separator can be used in the borehole if the quality of curves are deemed too low due to water based mud effects that are outside tool operating range.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

1. A method that comprises:
obtaining multi-component induction (MCI) measurements of a formation property from a logging tool conveyed along a borehole through a formation;
comparing a plurality of the MCI measurements to determine one or more data quality indicators for the formation property based at least in part on a predetermined inequality pattern;
displaying the one or more data quality indicators.

2. The method of claim 1, wherein the predetermined inequality pattern corresponds to:
σ_{IJ}^{(i+1, j)}≦σ_{IJ}^{(i, j)}≦σ_{IJ}^{(i-1, j)} or σ_{IJ}^{(i+1, j)}≧σ_{IJ}^{(i, j)}≧σ_{IJ}^{(i-1, j)},
where σ is a conductivity value, I indicates transmitter direction, and J indicates receiver direction.

3. The method of claim 1, wherein the plurality of the MCI measurement include measurements for different frequencies, and wherein the one or more data quality indicators are based at least in part on a degree of deviation between at least some of said measurements for different frequencies.

4. The method of claim 1, wherein the plurality of the MCI measurement include measurements for different sub-arrays, and wherein the one or more data quality indicators are based at least in part on a degree of deviation between at least some of said measurements for different sub-arrays.

5. The method of claim 1, wherein the plurality of the MCI measurement include multi-run measurements, and wherein the one or more data quality indicators is based at least in part on a degree of deviation between at least some of said multi-run MCI measurements.

6. The method of claim 1, further comprising combining at least some of the plurality of MCI measurements, wherein the one or more data quality indicators are based at least in part on a degree of deviation between at least some of said combined measurements.

7. The method of claim 1, further comprising displaying values for formation dip, vertical resistivity, and horizontal resistivity, and displaying a data quality indicator for each of said values.

8. The method of claim 1, wherein said displaying comprises displaying raw data corresponding to at least some of the compared MCI measurements, and displaying one or more data quality indicators for the raw data.

9. The method of claim 1, further comprising repeating said obtaining and said comparing until determined data quality indicators satisfy a cost function.

10. The method of claim 1, further comprising adjusting control parameters of the logging tool using automation rules based at least in part on the one or more data quality indicators.

11. A logging system that comprises:
a multi-component induction (MCI) logging tool to collect MCI measurements along a borehole through a formation;
at least one processor that:
compares a plurality of the MCI measurements to determine one or more data quality indicators based at least in part on a predetermined inequality pattern;
a display to selectively display the one or more data quality indicators.

12. The logging system of claim 11, wherein the compared MCI measurements include measurements collected for different runs of the logging tool.

13. The logging system of claim 11, wherein the compared MCI measurements include measurements collected for different frequencies of the logging tool.

14. The logging system of claim 11, wherein the compared MCI measurements include measurements collected for different sub-arrays of the logging tool.

15. The logging system of claim 11, wherein the predetermined inequality pattern corresponds to:
σ_{IJ}^{(i+1, j)}≦σ_{IJ}^{(i, j)}≦σ_{IJ}^{(i-1, j)} or σ_{IJ}^{(i+1, j)}≧σ_{IJ}^{(i, j)}≧σ_{IJ}^{(i-1, j)},
where σ is a conductivity value, I indicates transmitter direction, and J indicates receiver direction.

16. The logging system of claim 11, wherein the one or more data quality indicators are based at least in part on a degree of deviation between at least some of the compared MCI measurements.

17. The logging system of claim 11, wherein the at least one processor resides in the MCI logging tool.

18. The logging system of claim 11, wherein the at least one processor generates a report with raw data corresponding to at least some of the compared MCI measurements, and with one or more data quality indicators for the raw data.

19. The logging system of claim 11, wherein the at least one processor generates a report with processed data corresponding to at least some of the compared MCI measurements, and with one or more data quality indicators for the processed data.

20. The logging system of claim 11, wherein the at least one processor generates a report with inversion parameters corresponding to at least some of the compared MCI measurements, and with one or more data quality indicators for the inversion parameters.

21. The logging system of claim 11, wherein the at least one processor adjusts multi-run control parameters for the logging tool based on the one or more data quality indicators.
